(19) United States
(12) Patent Application Publication
(10) Pub. No.: US 2002/0162735 A1
(43) Pub. Date: Nov. 7, 2002

(54) Reduced energy water distillation and power turbine process

(76) Inventor: George H. Newman, Niceville, FL (US)

Correspondence Address: William G. Auton, ESC/JAZ 40 Wright Street, Hanscom AFB, MA, 01731-2903, US

(21) Appl. No.: 09/850,619

(22) Filed: May 7, 2001

(51) Int. Cl. B01D 3/10; C02F 1/14

(52) U.S. Cl. 203/11; 159/44; 159/903; 202/205; 202/234; 203/10; 203/4; 203/91; 203/100; 203/1; 203/18; 159/DIG. 16

(57) ABSTRACT

The present invention reduces the energy required to distill fluids (water, light crude, etc.) and operate electric and/or power generate steam turbines through a process of encapsulating these systems in reduced atmospheric temperature environments. This invention includes both the innovative process of operating existing distillers and turbines in a vacuum, and introduces an energy free process for drawing the vacuum the systems operate in.

### STATEMENT OF GOVERNMENTAL INTEREST

The invention described herein may be manufactured and used by or for the Government for governmental purposes without the payment of any royalty thereon.

### FIELD OF INVENTION

The present invention reduces the energy required to distill fluids (water, light crude, etc.) and operate electric and/or power generating steam turbines through process of encapsulating these systems in reduced atmospheric temperature environments. This invention includes both the innovative process of operating existing distillers and turbines in a vacuum, and introduces an energy free process for drawing the vacuum the systems operate in.

### BACKGROUND OF THE INVENTION

Availability of drinking water is currently the cause of serious concern to many nations, including the United States, Israel, and virtually all mid-east countries. Additionally, motor fuel refining capacity is limited and has failed to meet current and projected world-wide demands. As a result of both water and fuel limitations and projected future shortages, effective means are required to increase production of drinking/potable water in the mid-east and fuel production world-wide. Recognizing these resource requirements has inspired creation of this invention's unique processes.

Current methods of distilling water from the sea and fuels from crude are effective but costly in terms of energy used to heat the original fluids to vapor in the evaporative phase of distillation and steam generation. In the case of both water and fuel distillation, even if energy input is considered a negligible factor, the process of this invention will effectively increase distillation output for a given energy input. Additionally, the process of this invention should significantly enhance Israeli power turbine research and development which utilizes sun heated salt saturated water as the energy source.

The task of providing a system that reduces energy required to distill fluids (water, light crude etc.) and operate electric and/or power generating steam turbines is alleviated by the following U.S. Patents, the disclosures of which are incorporated herein by reference:

U.S. Pat. No. 4,203,806, issued May 20, 1980 to Diggs.

U.S. Pat. No. 4,235,680, issued Nov. 26, 1980 to Diggs.

U.S. Pat. No. 4,343,683, issued Aug. 10, 1982 to Diggs.

U.S. Pat. No. 4,381,222, issued Apr. 26, 1983 to Brossmann et al.

U.S. Pat. No. 4,399,368, issued Aug. 16, 1983 to Bucknam.

U.S. Pat. No. 4,431,385, issued Feb. 14, 1984 to O'Hare.

All of the above-cited patents are for distillation technology.

Current methods of distilling water from the sea and fuels from crude are effective but costly in terms of energy used to heat the original fluids to vapor in the evaporative phase of distillation and steam generation. In the case of both water and fuel distillation, even if energy input is considered a negligible factor, the process of the present invention will effectively increase distillation output for a given energy input.

### SUMMARY OF THE INVENTION

The present invention encompasses two processes: A drawing system vacuum via solar heating and cooling; and operating distillation and power turbine processes in a vacuum/reduced pressure environment. The essence of the second process is to take advantage of relationship between fluid boiling point and its surrounding pressure.

Drawing system vacuum for distillation and/or power turbine operation: the system consists of at least three airtight chambers—one houses the distillation or power turbine hardware; and the second/subsequent chambers are exposed to focused solar radiation and used to create system vacuum. This vacuum is created solely by solar energy, and does not rely upon pumps driven by any other energy source—essentially, the cost of vacuum and resulting distillation/turbine gains are free.

A vacuum is created through a series of solar cycles in the second and subsequent chambers where the steps are further described herein in the section entitled “Detailed Description of Invention.” The process uses a combination of solar heated/radiation cooled gas expansion/contraction to draw the initial vacuum; and differential pressure diaphragm actuated piston pumps to draw the high-end vacuum. The vacuum created from each successive day's solar pumping action is applied to the distillation/power turbine chamber environment/vacuum through one-way check valves and associated piping between the chambers which allows the created vacuum to act upon the distillation/power turbine chamber pressure through a pressure equalization process. Vacuum pumping action can go on indefinitely while the distillation/turbine power production goes on in its chamber.

The distillation and/or steam generated power turbine operation part of this invention takes advantage of the relationship between a fluid boiling point and its surrounding pressure. Creating a vacuum or low pressure environment around the fluids acted upon during distillation and/or steam production for driving a power turbine, results in lowering the fluid's boiling point in direct relation to the amount of vacuum created. As a result, more fluid is boiled/distilled, and more steam for power production is produced for a given energy used to boil the fluids. This in-turn results in increased efficiency and/or desired output.

### BRIEF DESCRIPTION OF DRAWINGS

FIG. 1 is a diagram of the two part system depicting vacuum creating chambers and distillation hardware.

### DETAILED DESCRIPTION OF THE INVENTION

The present invention encompasses two processes—drawing free system vacuum via solar heating and cooling; and operating distillation and power turbine processes in the vacuum/reduced pressure environment. The essence of the second process is to take advantage of a relationship between fluid boiling point and its surrounding pressure.

A drawing system vacuum for distillation and/or power turbine operation: the system consists of at least three airtight chambers—one houses the distillation or power turbine hardware; and the second/subsequent chambers are exposed to focused solar radiation and used to create system vacuum. This vacuum is created solely by solar energy, and does not rely upon pumps driven by any other energy source—essentially, the cost of vacuum and resulting distillation/turbine gains are free.

A vacuum is created through a series of solar cycles in the second and subsequent chambers. The process uses a combination of solar heated/radiation cooled gas expansion/contraction to draw the initial vacuum; and differential pressure diaphragm—actuated piston pumps to draw the high-end vacuum. The vacuum created from each successive day's solar pumping action is applied to the distillation/power turbine chamber environment/vacuum through one-way check valves and associated piping between the chambers which allows the created vacuum to act upon the distillation/power turbine chamber pressure through a pressure equalization process. The vacuum pumping action can go on indefinitely while the distillation/turbine power production goes on in its chamber.

The distillation and/or steam generated power turbine operation part of this invention takes advantage of the relationship between a fluid boiling point and its surrounding pressure. Creating a vacuum or low pressure environment around the fluids acted upon during distillation and/or steam production for driving a power turbine, results in lowering the fluid's boiling point in direct relation to the amount of vacuum created. As a result, more fluid is boiled/distilled, and more steam for power production is produced for a given energy used to boil the fluids. This in-turn results in increased efficiency and/or desired output.

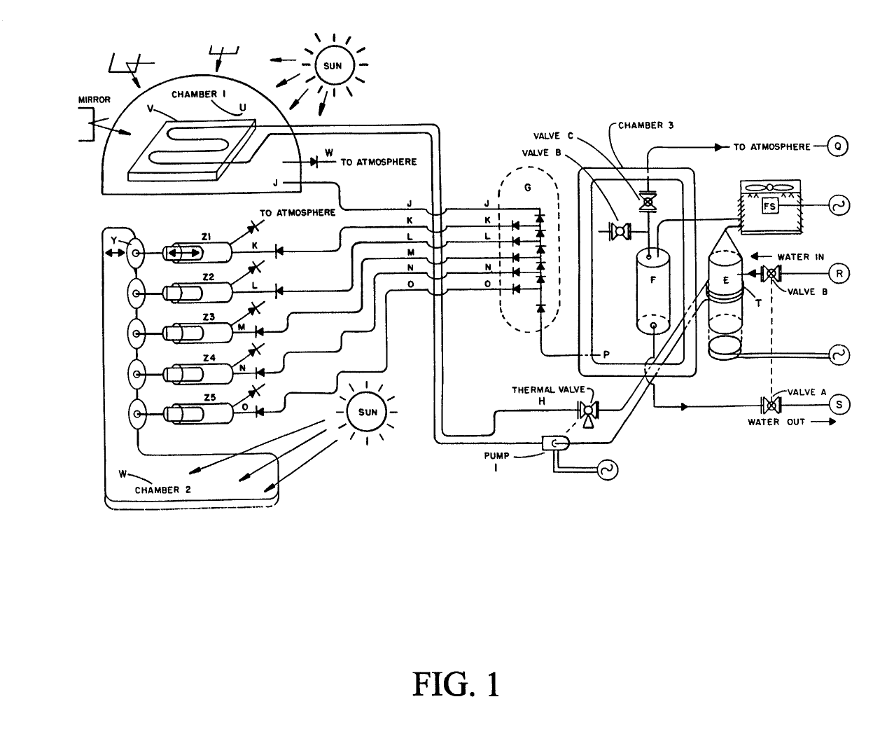

The invention depicted in FIG. 1 shows for simplicity how the invention is applied to a water or fuel distillation process. The invention process applies equally well to operating a steam power turbine, and can be effected by replacing the distillation hardware with that of a power turbine assembly in Chamber 3.

The invention depicted in FIG. 1 shows the vacuum pumps, which are illustrated as Chambers 1 and 2, containing (Y) diaphragm-actuated piston pumps (Z-1 through Z-5); a network of one-way check valves; Chamber 3 containing part of the distillation hardware (F) and pressure control valves (C and D); the remainder of the distillation hardware (E, T, H, and I); and the remainder of the pressure control valves A and B.

The cycle of operation is essentially continuous, but for sake of system explanation, the process explanation starts with Step 1, drawing maximum available vacuum in Chamber 3.

Vacuum pumping continues over course of days and nights, with each of the pumping cycles directly in synchrony with solar heating and night's radiational cooling of vacuum pump system.

Chamber 1's positive pressure is vented to atmosphere via one-way check valve (W).

Chamber 2, and subsequent similar diaphragm-pumping assemblies are sealed to the atmosphere, so that no air can enter or escape.

Vacuum pumping in Chamber 1, 2, and subsequent diaphragm-pumping assemblies occur at same time, but specific operations are described sequentially, as follows:

Drawing maximum available vacuum in Chamber 3:

Sun warms air in Chamber 1

Air expands as result of solar heating and vents to ambient atmosphere through (W).

Flat black heating augmentation plate & water-heat exchanger (V) is heated by solar radiation and resultant hot water is routed to Tank (E) of distillation assembly to augment heating/boiling non-potable fluid.

Sun falls and trapped air in Chamber 1 cools and contracts. Since vent (W) is a one-way “outflow” valve, ambient air cannot enter Chamber 1. As a result of the cooling, a vacuum is created, which pulls air from Chamber 3 through check valve (J) and associated piping into Chamber 1, where vacuum in both chambers equalize.

Process repeats itself as day/night cycles progress, and with each cycle, more system vacuum is produced.

Note: The next chamber and additional chambers like it (e.g. Chamber 2), contain a series of descending radius piston vacuum pumps to draw maximum vacuum. The smaller the vacuum pump piston area for given diaphragm area, the greater the piston's pumping leverage and greater the vacuum-drawing capability.

Sun warms air in Chamber 2 and subsequent chambers, causing heated air to expand, as follows:

Expanding air acts upon diaphragms (Y) which are mechanically linked to vacuum piston pumps Z-1 through Z-5.

Pistons in Z pumps are pushed to the right by diaphragm expansion as air heats and pressurizes Chamber 2.

Air is subsequently forced from right side of pistons in each Z pump through each pump's one-way check valve to atmosphere.

Sun goes down and Chamber 2 cools. This results in the chamber's internal air to contract, creating a vacuum, which in-turn acts on the pumping diaphragms (Y) to pull/move them inward to the left.

Diaphragms (Y) movement to left moves their mechanically attached vacuum pump Z pistons to the left, where leveraged vacuum is created at points K, L, M, N, and O.

This increased vacuum pulls additional vacuum in Chamber 3 through a network of piping and individual one-way check valves.

Process repeats itself as day/night cycles progress, and with each cycle, more system vacuum results until system vacuum pumping capability is physically reached.

The vacuum sequence valve assembly (G) is designed/used in Chamber 2's vacuum pumping process as follows:

As vacuum pumping cycles progress, vacuum at point (P) “Chamber 3” equals or surpasses vacuum pumping capability of Chamber 2's Pump Z-1. Once this occurs, Z-1 no longer contributes to vacuum pumping/system vacuum increase, and vacuum integrity for remainder of pumping network is maintained by one-way check valves (K) to Z-1.

Vacuum pumping cycles continue and vacuum is drawn by remaining Z smaller radius Z pumps while Z-1 is effectively isolated from the system.

Vacuum at (P) eventually equals or surpasses Z-2's vacuum drawing capability, and it's one-way check valves (L) isolates it from the system.

The same process occurs as system vacuum builds until vacuum at P equals the final Z pump's vacuum drawing capability. At this point, no greater system vacuum is possible unless more Z pumps of increasingly smaller piston radius are added to the system; larger diaphragms are used to actuate the Z pumps; and/or, greater temperature changes within sealed Chamber 2 is created to increase diaphragm and Z pump throws.

Filling Distillation System's Evaporation Tank and Harvesting Distilled Fluid Product

Filling the distillation system's evaporation tank (E) and harvesting distilled fluid product from Tank (F) without significantly disturbing or losing system vacuum in Chamber 3 is performed as follows:

Valve D (normally open) closes to prevent loss of vacuum to atmosphere when Valve C opens, and

Valve C (normally closed) opens Tank F to atmosphere.

Valves A and B (normally closed) open to allow pressurized unprocessed fluid to enter Tank E and harvest distilled fluid from Tank F through (S).

Valves A, B, and C close once Tank E is filled to desired level, and Tank F is empty.

Valve D opens to allow system vacuum to act upon Tanks E and F.

Fluid is distilled from Tanks E to F, where draining/filling process described above repeats itself.

1. A water distillation system comprising: a solar heated means for heating undistilled fluids to produce a fluid vapor during solar heating, said solar heated means being sealed after the end of effective sunlight to create a partial vacuum during cooling to be used to draw further undistilled fluids at a start of the next solar cycle; and a distillation chamber which collects and condenses the fluid vapor to produce distilled fluids.

2. A water distillation system, as defined in claim 1, wherein said solar heated means comprises a fluid chamber containing an intake tube connected to an undistilled fluid supply, an output tube for venting the fluid vapor to the distillation chamber, a controllable valve system that allows venting of fluid vapor during effective sunlight but closes during cooling to generate the partial vacuum.

3. A water distillation system, as defined in claim 2, further comprising a second solar heated chamber that heats undistilled fluids into fluid vapor for the distillation chamber.

4. A water distillation system, as defined in claim 3, wherein said first and second chambers are equipped with one-way valves that permit the exit of fluid vapors to the distillation chamber and the intake of undistilled fluids from the supply.

5. A process for using solar heating for effective distillation, said process comprising the steps of: heating undistilled fluids in a chamber with one-way valves so that fluid vapor is exhausted to a distillation chamber during sunlight, but the chamber is cooled to create a partial vacuum to draw undistilled fluids in at the beginning of each successive solar cycle.
